(19) United States
(12) Patent Application Publication
(10) Pub. No.: US 2011/0195279 A1
(43) Pub. Date: Aug. 11, 2011

(54) METHOD FOR MANUFACTURING GLASS SUBSTRATE FOR INFORMATION RECORDING MEDIUM, GLASS SUBSTRATE FOR INFORMATION RECORDING MEDIUM, AND MAGNETIC RECORDING MEDIUM

(75) Inventors: Shinichi Saeki, Sakai-shi (JP); Futoshi Ishida, Takatsuki-shi (JP); Koji Kato, Kishiwada-shi (JP)

(73) Assignee: Konica Minolta Opto, Inc., Hachioji-shi, Tokyo (JP)

(21) Appl. No.: 12/674,986

(22) PCT Filed: Aug. 19, 2008
(86) PCT No.: PCT/JP2008/064729

§ 371 Date: Feb. 24, 2010

(30) Foreign Application Priority Data
Sep. 4, 2007 (JP) 2007-228714

(51) Int. Cl. G11B 5/84; B08B 1/04; C03C 23/00; B24B 1/00

(52) U.S. Cl. 428/846.9; 134/2; 428/64.2; 451/41

(57) ABSTRACT

A method for manufacturing a glass substrate for an information recording medium, wherein the abrasive and foreign matters adhered on the glass substrate after the polishing step are surely removed without making the cleaning step complicated. The glass substrate is cleaned by scrubbing with water to which 0.5-5.0 mass % of hydrogen peroxide has been added as a cleaning solution.

### TECHNICAL FILED

The present invention relates to a manufacturing method of a glass substrate for an information recording medium, a glass substrate for an information recording medium and a magnetic recording medium.

### BACKGROUND

In the past, as substrates for a magnetic disk, aluminum alloys have been used for stationary type information devices such as desktop computers and servers, and glass substrates have been employed for portable type information devices such as notebook computers and mobile computers. Surface-smoothness of the aluminum alloy substrates after being polished tends to be insufficient since aluminum alloys are deformable, and also their hardness is insufficient. Further, there was another problem that a magnetic layer was easy to be peeled off from the substrate when a recording head was mechanically brought into contact with a magnetic disk. Thus, glass substrates exhibiting reduced deformation, excellent surface-smoothness and high mechanical strength are expected to be utilized in the future for stationary type information devices as well as portable type information devices, and also for other information devices for domestic use.

By the way, the storage capacity of a magnetic disk can be increased in proportion to the amount of decreasing the distance between a magnetic recording head and the surface of a magnetic disk. However, when the distance between a magnetic recording head and the surface of a magnetic disk is decreased, if there is an abnormal projection on the surface of a glass substrate or if there is adhesion of a foreign matter, there may occur the failure that a magnetic recording head collides with the projection on a magnetic disk or with the foreign matter. Therefore, in order to increase the storage capacity of a magnetic disk by decreasing the distance between a magnetic recording head and the surface of a magnetic disk, it is necessary to remove surely abnormal projections and foreign matters adhered on the surface of a glass substrate. Then, the surface of the glass substrate was polished using abrasive compounds, such as cerium oxide, and the surface smoothness of the glass substrate was secured.

However, when a glass substrate is polished with an abrasive compound, there may remain the abrasive compound in the state of firmly adhered to the surface of the glass substrate. Therefore, even if the glass substrate surface after being polished was cleaned with scrub cleaning, it was difficult to remove thoroughly the abrasive compound which adhered firmly. Moreover, if a magnetic recording layer is formed on a glass substrate surface with the abrasive compound adhered on it, there may occur the problems which reduce remarkably the magnetic recording properties by appearance of pinholes in the magnetic recording layer or by becoming unstable floating characteristics of a recording head.

Then, for example, in Patent document 1, there is proposed a method of performing three kinds of cleaning after polishing process: ultrasonic cleaning with a detergent, scrub cleaning, and ultrasonic cleaning with pure water. Moreover, in Patent document 2, there is proposed washing a glass substrate with the combination of scrub cleaning and washing with water containing carbon dioxide gas.
Patent document 1: Japanese Patent Application Publication (JP-A) No. 2002-74653
Patent document 2: JP-A No. 2003-228824

### DISCLOSURE OF THE INVENTION

### Problems to be Solved by the Invention

However, according to Patent document 1, it is thought that the abrasive compound adhered to a glass substrate can be removable to some extent, but with this technical proposal, since as many as three kinds of cleaning are applied, there is a possibility that a cleaning process may be complicated and manufacturing efficiency may fall. Moreover, the technical proposal of the Patent document 2 requires introduction of a control and maintenance apparatus of gas solubility, and similar to the technical proposal of Patent document 1, it has a possibility that a cleaning process may be complicated and manufacturing efficiency may fall.

The present invention has been achieved to resolve these problems. An object of the present invention is to provide a manufacturing method for a glass substrate for an information recording medium, in which an abrasive compound and a foreign matter adhered to a glass substrate are removed certainly, without making a cleaning process complicated, and to provide a glass substrate for an information recording medium made by this manufacturing method.

Moreover, another object of the present invention is to provide a magnetic recording medium which can enlarge storage capacity by decreasing the distance between a magnetic recording head and a surface of a magnetic recording medium.

### Means to Solve the Problems

The above-described objects of the present invention can be accomplished by the following structures.

1. A method for manufacturing a glass substrate for an information recording medium comprising the step of:

scrub cleaning the glass substrate using a scrub member and a washing liquid,

wherein the washing liquid is hydrogen peroxide water containing hydrogen peroxide in an amount of 0.5 to 5.0 weight %.

2. The method for manufacturing a glass substrate for an information recording medium of the above-described item 1,

wherein the washing liquid is hydrogen peroxide water containing hydrogen peroxide in an amount of 1.0 to 3.0 weight %.

3. The method for manufacturing a glass substrate for an information recording medium of the above-described items 1 or 2,

wherein the method comprises the step of:

polishing the glass substrate; and then

scrub cleaning the glass substrate after polishing the glass substrate.

4. The method for manufacturing a glass substrate for an information recording medium of any one of the above-described items 1 to 3,

wherein the scrub member is a rotary roller having a sponge on a surface of the rotary roller, scrub cleaning is carried out by making contact the rotary roller with the glass substrate, and the washing liquid is dropped in a vicinity of a contact portion of the rotary roller with the glass substrate.

5. The method for manufacturing a glass substrate for an information recording medium of the above-described item 4,

wherein the sponge has a void ratio of 20 to 80%.

6. The method for manufacturing a glass substrate for an information recording medium of the above-described items 4 or 5,

wherein the sponge has a hardness of 30 to 70.

7. The method for manufacturing a glass substrate for an information recording medium of any one of the above-described items 4 to 6,

wherein the sponge is made of a hydrophilic resin material.

8. A glass substrate for an information recording medium produced with the method of any one of the above-described items 1 to 7.

9. A magnetic recording medium comprising the glass substrate of the above-described item 8 and a magnetic layer which is provided on a surface of the glass substrate.

### Effects of the Invention

In the manufacturing method of a glass substrate for an information recording medium of the present invention, water added 0.5-5.0 weight % of hydrogen peroxide is used as a washing liquid. Accordingly, the hydrophilicity of the surface of a scrub member is improved and the contact area of a scrub member and a glass substrate becomes large. For this reason, cleaning of an abrasive compound or a foreign matter by scrub cleaning can be surely performed.

Moreover, in the manufacturing method of a glass substrate for an information recording medium of the present invention, since a glass substrate is washed with the above-mentioned cleaning method, an abrasive compound and an foreign matter are removed off from a surface of a glass substrate, and at the same time a cleaning process is simplified and improvement in manufacturing efficiency can be expected.

Furthermore, in a magnetic recording medium of the present invention, since a magnetic recording layer is formed on the glass substrate manufactured by the above-mentioned manufacturing method, the distance of a magnetic recording head and a magnetic recording intermediation body surface can be decreased, and, thereby, storage capacity can be enlarged.

### BRIEF DESCRIPTION OF THE DRAWINGS

FIG. 1 is a schematic drawing of an entire structure of a glass substrate for an information recording medium.

FIG. 2 is a schematic drawing showing an example of a magnetic recording medium in which a magnetic layer is provided on the front main surface of a glass substrate for an information recording medium.

FIG. 3 is a flow chart showing an example of a manufacturing process of a glass substrate for an information recording medium.

FIG. 4 is a schematic drawing showing an example of a roll scrub cleaning apparatus

FIG. 5 is a schematic drawing showing an example of a cup scrub cleaning apparatus

### DESCRIPTION OF SYMBOLS

1: Glass substrate for an information recording medium (glass substrate)
2: Magnetic layer
5: Hole
7a: Front main surface
7b: Back main surface
10t: Outer circumferential end face
20t: Inner circumferential end face
10a, 10b, 50a and 50b: Sponge roller
20: Nozzle
30: Washing liquid
40: Support roller
D: Magnetic disk

### PREFERRED EMBODIMENTS TO CARRYOUT THE INVENTION

The present invention will be described based on the embodiments shown in the figures, however, the present invention is not limited to these embodiments.

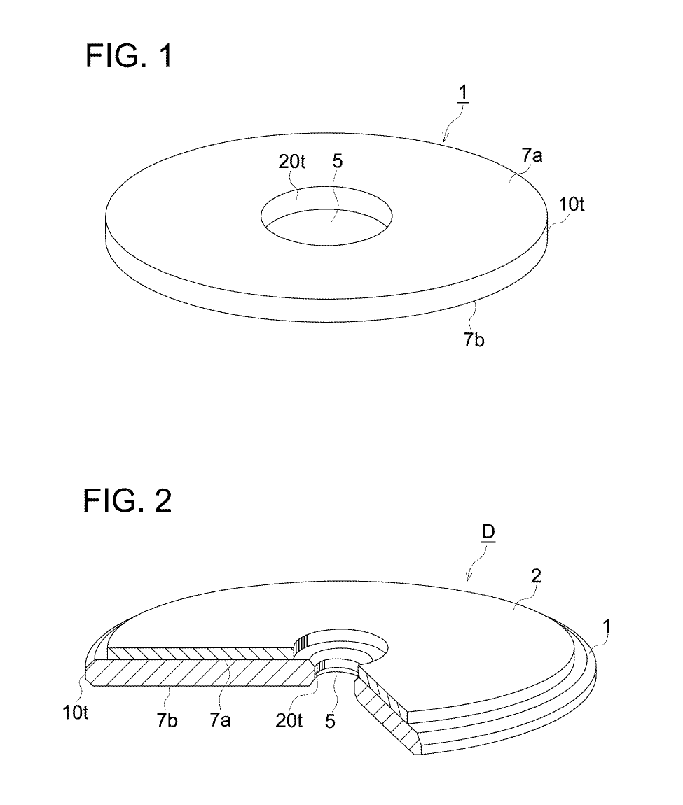

FIG. 1 shows an entire structure of glass substrate 1 for an information recording medium in the present invention (hereinafter, it is also referred to as a glass substrate). As shown in FIG. 1, glass substrate 1 is in the form of a circular disk where hole 5 is formed in the center. 10t represents an outer circumferential end face, 20t represents an inner circumferential end face, 7a represents a front main surface and 7b represents a back main surface.

Further, FIG. 2 shows an example of magnetic recording medium D (hereinafter, it is also referred to as a magnetic disk) in which magnetic layer 2 is provided on front main surface 7a of glass substrate 1 shown in FIG. 1. Magnetic layer 2 can be also provided on back main surface 7b.

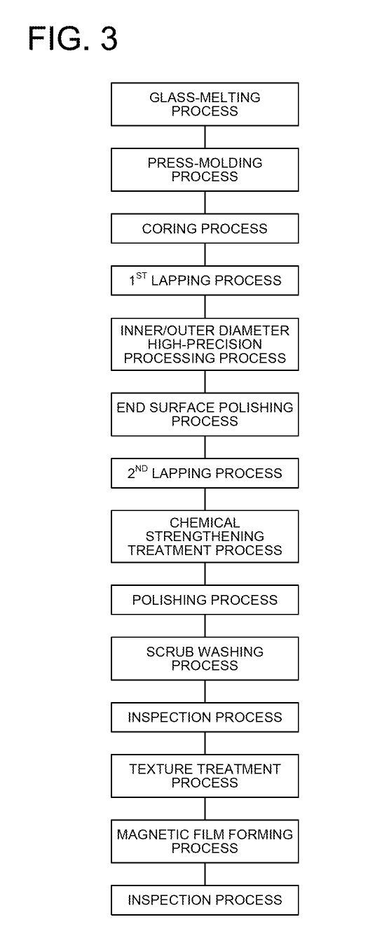

FIG. 3 shows a flow chart showing an example of a manufacturing method of a glass substrate for an information recording medium of the present invention.

One of the most distinctive features of the manufacturing method of a glass substrate for an information recording medium of the present invention is to wash a glass substrate using water which was added hydrogen peroxide as a washing liquid in the scrub washing process. Accordingly, the hydrophilicity of the surface of a scrub member is improved and the contact area of a scrub member and a glass substrate becomes large. For this reason, cleaning of an abrasive compound or a foreign matter by scrub cleaning can be surely performed.

The concentration of hydrogen peroxide in the washing liquid used in the present invention is required to be 0.5 to 5.0 weight %. The concentration is more preferably 1.0 to 3.0 weight %. When the concentration of hydrogen peroxide in the washing liquid to be used is less than 0.5 weight %, the hydrophilicity of the surface of a scrub member will be hardly improved. Therefore, the contact area of a scrub component with a glass substrate does not become large enough. Moreover, when the added amount of hydrogen peroxide in the washing liquid to be used exceeds 5.0 weight %, the scrub member will be deteriorated and a lifespan of the scrub member will become short. Therefore, the replacement frequency of the scrub member will be increased, and this will lead to cost increase while manufacturing efficiency falls.

The manufacturing process of a glass substrate for information recording medium will be described in detain by referring to a manufacturing flow chart shown in FIG. 3.

### (Glass-Melting Process)

At first, a glass material is melted in a glass melting process. Usable examples of a glass substrate include soda lime glass composed of SiO₂, Na₂O, and CaO as a principal component; aluminosilicate glass composed of SiO₂, Al₂O₃, R₂O (R═K, Na, and Li) as a principal component; borosilicate glass; Li₂O—SiO₂ system glass; Li₂O—Al₂O₃—SiO₂ system glass; and R′O—Al₂O₃—SiO₂ system glass (R′=Mg, Ca, Sr, and Ba). Of these, aluminosilicate glass and borosilicate glass are preferable in view of excellent impact resistance and excellent vibration resistance.

### (Press-Molding Process)

Then, in the press-molding process, the melted glass is loaded into a down mold and is press molded with an upper mold to obtain a disc-form glass substrate precursor. In addition, a disc-form glass substrate precursor may be produced by cutting down the sheet glass which was formed, for example, with the down draw method or the float method, with a grinding stone, without using press-molding process.

There is no limitation in the magnitude of a glass substrate to be used. For example, the glass substrate having a various outer size of 2.5 inches, 1.8 inches, 1 inch, and 0.8 inch can be used. Moreover, there is also no limitation in the thickness of a glass substrate, and the glass substrate of various thicknesses, such as 2 mm, 1 mm, and 0.63 mm, can be used.

### (Coring Process)

A hole is made in the central part of the glass substrate precursor produced by press molding process in a coring process. Boring a hole is carried out in the central part of the glass by grinding with the core drill which equipped the diamond grindstone on the cutter part of the core drill.

### (1^{st} Lapping Process)

Next, in the 1st lapping process, polishing work of both surface sides of a glass substrate is performed, and preliminary adjustment of the whole shape of a glass substrate, i.e., the parallel accuracy, flatness, and the thickness of a glass substrate, is carried out.

### (Inner and Outer Diameter High-Precision Process)

Then, in the inner and outer diameter high-precision process, the outer circumferential end face and the inner circumferential end face of the glass substrate are ground, for example, with grindstones such as a drum-shape diamond, and the inner and the outside diameter are processed.

### (End Surface Polishing Process)

A plurality of glass substrates which were finished the inner and the outside diameter processing process are piled up and are laminated. In that state, the outer circumferential end face and the inner circumferential end face of the glass substrate are polished using an end polishing machine.

### (2^{ed} Lapping Process)

Further, both surfaces of the glass substrate are polished again to fine tune the parallel accuracy, flatness, and the thickness of the glass substrate.

As a polishing machine which grinds both surfaces of the top side and the rear side of a glass substrate in the 1^{st} and 2^{nd} lapping processes, a well-known polishing machine called a double-sided grinder can be used. The double-sided grinder is equipped with an upper platen and a lower platen of a disc shape which have been arranged at an upper position and at a under position of the glass substrate so that they may be parallel mutually, and they rotate to a reverse direction mutually. There are adhered a plurality of diamond pellets for grinding the main surfaces of a glass substrate on each side of the upper platen and the lower platen which face with each other. Between the upper platen and the lower platen, there is a plurality of carriers which rotate by combining with internal gears located at the outer circumference of the lower platen in a circle state and a sun gear located in the circumference of the rotary shaft of the lower platen. In this carrier, two or more holes are prepared, and a glass substrate is inserted in these holes to hold the glass substrate. The upper platen and the lower platen, the internal gears and the sun gear can be operated by a separate driving device.

A polishing operation of a polishing machine is performed as follows. The upper platen and the lower platen rotate to a reverse direction mutually. On the other hand, the carrier inserted into the platen through the diamond pellet revolves in the same direction as a lower platen with rotating on its axis of the carrier, while holding two or more glass substrates. In the polishing machine which operates these movements, a glass substrate can be polished by a grinding liquid supplied between the upper platen and the glass substrate, and between the lower platen and the glass substrate.

When this double-sided grinder is used, the load to the platen added to the glass substrate and the rotational frequency of the platen are suitably adjusted according to desired polishing conditions. As for the load in the 1^{st} and 2^{nd} lapping processes, it is preferable that load is from 60 g/cm² to 120 g/cm². Moreover, the rotational frequency of the platen is preferably set to be about 10 rpm to 30 rpm, and it is preferable to set the rotational frequency of the upper platen to be smaller speed than the rotational frequency of the lower platen by about 30% to 40%. When the load by the platen is increased and the rotational frequency of the platen is increased, an amount of polishing will increase, but the surface roughness will not become satisfactory when the amount of the load is too much. On the other hand, flatness will not become satisfactory when the rotational frequency is too quick. Moreover, when the load is small and the rotational frequency of the platen is slow, there will be little polishing quantity, as a result, production efficiency will become low.

After finishing the 2^{nd} lapping process, it is preferable that the defects such as a large undulation, a void and a crack are removed. With regard to the surface roughness of the main surfaces of the glass substrate, it is preferable that Rmax is about 2 μm to 4 μm, and Ra is about 0.2 μm to 0.4 μm. By changing into these surface states, the glass substrate can be polished efficiently by the 1^{st} polishing process through the following chemical strengthening process.

In addition, in the 1^{st} lapping process, a large undulation, a void, and a crack are roughly and efficiently removed so that the 2^{nd} lapping process can be performed efficiently. For this reason, in the 1^{st} lapping process, it is desirable to use a diamond pellet having a roughness from #800 mesh to #1200 mesh, which are coarser than the diamond pellet having a roughness from #1300 mesh to #1700 mesh used in the 2^{nd} lapping process. After finishing the 1^{st} lapping process, it is preferable that the surface roughness of Rmax is about 4 μm to 8 μm, and Ra is about 0.4 μm to 0.8 μm.

Moreover, as a way of grinding a glass substrate, it can be also be used the following method in which a pad is adhered on the polishing surface of the upper platen and the lower platen and a polishing liquid containing an abrasive compound is supplied to grind the glass substrate. Examples of an abrasive compound include: cerium oxide, zirconium oxide, aluminium oxide, manganese oxide, colloidal silica and diamond. These are dispersed with water and they are used as a slurry form. Although the type of a pad can be divided into a hard pad and an elasticity pad, any pad can be chosen suitably and can be used according to requirement. As a hard pad, a pad made of hard velour, urethane foaming, or pitch inclusion suede can be cited. As an elasticity pad, a pad made of suede or velour can be cited.

The polishing method which uses a pad and an abrasive compound can respond from rough grinding to precision polishing by changing the grain size of an abrasive compound, and the type of pad. This method enables to remove a large undulation, a void and a crack in the 1^{st} lapping process and in the 2^{nd} lapping process to obtain the above-mentioned surface roughness by suitably combining the kind of an abrasive compound, the grain size of an abrasive compound and, and a kind of a pad.

Moreover, it is desirable to perform the cleaning process for removing the abrasive compound and glass powder which are remained on the surface of the glass substrate after the 1^{st} and 2^{nd} lapping processes.

In addition, although the polishing machine used in the 1^{st} lapping process and in the 2^{nd} lapping process may have an identical configuration, it is desirable to perform polishing operation using a different polishing machine prepared only for each manufacturing process. If the same polishing machine is used, there will be needed an operation of large-scale exchange, and a complicated operation of carrying out a readjustment of the polishing conditions since there is adhered the diamond pellet for exclusive use for each process, and as a result, production efficiency will be decreased.

### (Chemical Strengthening Process)

After the completion of the 2^{nd} lapping process, the chemical strengthening process is performed, in which the glass substrate is immersed in a chemical strengthening liquid to form a chemical strengthening layer on the glass substrate. By forming the chemical strengthening layer, improvement of impact resistance and vibration resistance can be achieved.

A chemical strengthening process is performed by immersing a glass substrate in the heated chemical strengthening treatment liquid. By this process, an ion exchange is carried out by which alkali metal ions contained in the glass substrate, such as lithium ions and sodium ions, are substituted with alkali metal ions, such as potassium ions having a larger ion radius. From the distortion produced by the difference in an ion radius, compressive stress occurs to the portion where the ion exchange was carried out, and the surface of the glass substrate is strengthened.

There is no particular restriction to the chemical strengthening treatment liquid, and a well-known chemical-strengthening treatment liquid can be used. Usually, it is common to use a fused salt containing potassium ions or a fused salt containing potassium ions and sodium ions. As a fused salt containing potassium ions or sodium ions, nitrate, carbonate and sulfate of potassium or sodium, and the mixed fused salts of these can be cited. Especially, it is preferable to use nitrate from the viewpoint that it has a low melting point and it can prevent deformation of a glass substrate.

The chemical strengthening treatment liquid is heated so that it becomes a higher temperature than the melting temperature of the above-mentioned components. On the other hand, when the heating temperature of the chemical strengthening treatment liquid is too high, the temperature of the glass substrate will rise too much, and there is a possibility of causing deformation of the glass substrate. For this reason, the heating temperature of the chemical strengthening treatment liquid is preferably lower than the glass transition point (Tg) of the glass substrate, and it is more preferable that the heating temperature is lower than the glass transition point minus 50° C.

In addition, in order to prevent a crack of a glass substrate and the development of a minute crack by the thermal shock at the time of being immersed in the heated chemical strengthening treatment liquid, the glass substrate may be subjected to a preheating process which heats the glass substrate to the prescribed temperature in a preheating bath in advance of the immersion in the chemical-strengthening treatment liquid.

By considering both improving the strength of a glass substrate and shortening the time required for a polishing process, the thickness of the chemical strengthening layer is preferably about 5 μm to 15 μm. When the thickness of the strengthening layer is in this range, it can be obtained a good glass substrate having a good flatness and a good shock resistance which is a mechanical strength.

The shape of the outer circumferential edge portion of the front main surface 7a and the back main surface 7b after a chemical strengthening process will not be changed much compared to the shape before the chemical strengthening process. They will be in the state where the above-mentioned chemical strengthening layer of a thickness of about 5 μm to 15 μm is placed on the whole surface of the glass substrate.

### (Polishing Process)

Next, a polishing process as a grinding process is performed.

In the polishing process, the surface of the glass substrate is finished precisely, and at the same time, the form of the outer circumferential edge portion on the main surfaces will be ground in a predetermined form. Although one polishing process may be sufficient, however, two polishing processes are more preferable.

First, in the 1^{st} polishing process, in order to achieve efficiently the last targeted surface roughness by the 2^{nd} polishing process, polishing enabling to improve the surface roughness and to form the targeted shape of the present invention efficiently is performed.

The way of polishing is as follows. The grinder of the same composition as the grinder used in the 1^{st} and 2^{nd} lapping processes is used for the polishing process except that the diamond pellet and the grinding liquid which are used in the lapping process are replaced with a pad and a polishing liquid.

A preferable pad is a hard pad having hardness A of about 80 to 90, and it is preferable to use foaming urethane, for example. By generation of heat by polishing, the hardness of a pad becomes soft and the shape change of a polished surface becomes large. Therefore, it is preferable to use a hard pad. As for an abrasive compound, it is preferable to use, for example, cerium oxide having a particle size of 0.6 to 2.5 μm and dispersed in water to form slurry. The mixing ratio of water to the abrasive compound is preferably about 1:9 to 3:7.

The load to the glass substrate by a platen is preferably from 90 g/cm² to 110 g/cm². The load to the glass substrate by a platen affects greatly the form of a circumferential edge portion. When the load is increased, there is a tendency that the interior of the circumferential edge portion falls and the edge portion goes up toward an outside. Moreover, when the load is decreased, the circumferential edge portion shows a tendency of increasing a surface roll-off while becoming close to a plane. The load can be decided after observing these tendencies.

Moreover, in order to improve surface roughness, the rotational frequency of the platen is preferably set to be about 25 rpm to 50 rpm, and it is preferable to set the rotational frequency of the upper platen to be smaller speed than the rotational frequency of the lower platen by about 30% to 40%.

By controlling the above-described conditions, it is preferable that the amount of polishing is from 30 μm to 40 μm. When it is less than 30 μm, scratches or defects cannot be sufficiently removed. When it is larger than 40 μm, although the surface roughness Rmax can be achieved to be in the range of 2 nm to 60 nm and the surface roughness Ra can be achieved to be in the range of 2 nm to 64 nm, the amount of polishing is more than required, as a result, production efficiency is lowered.

The 2^{nd} polishing process is a manufacturing process of grinding more precisely the surface of the glass substrate after completion of the 1^{st} polishing process. The pad used in the 2^{nd} polishing process is preferably an elastic pad having the hardness of about 65 to 80 (Asker-C) and softer than the pad used in the 1^{st} polishing process. It is preferable to use foaming urethane or suede, for example. Although the same cerium oxide as used in the 1^{st} polishing process can be used as an abrasive compound, in order to smooth the surface of a glass substrate more, it is preferable to use an abrasive compound having a finer particle size with limited particle size dispersion. Ii is preferable that the abrasive compound having an average grain diameter of 40 to 70 nm is dispersed in water to obtain a slurry form, and the slurry is used as a polishing liquid. The mixing ratio of water to the abrasive compound is preferably about 1:9 to 3:7.

The load to the glass substrate by a platen is preferably from 90 g/cm² to 110 g/cm². Although the load to the glass substrate by a platen affects greatly the form of a circumferential edge portion in the same manner as in the 1^{st} polishing process, the form of the glass substrate cannot be changed as efficiently as in the 1^{st} polishing process because the polishing speed of the 2^{nd} polishing process is small. The change of the form of the circumferential edge portion produced by the change of the load is the same as that of the 1^{st} polishing process. When the load is increased, there is a tendency that the interior of the circumferential edge portion falls and the edge portion goes up toward an outside. Moreover, when the load is decreased, the circumferential edge portion shows a tendency of increasing a surface roll-off while becoming close to a plane. In order to achieve the form of the circumferential edge portion, the load can be decided after observing these tendencies. The rotational frequency of the platen is preferably set to be about 15 rpm to 35 rpm, and it is preferable to set the rotational frequency of the upper platen to be smaller speed than the rotational frequency of the lower platen by about 30% to 40%.

As mentioned above, it can be achieved to obtain the required circumferential edge portion form by adjusting the polishing condition in the 2^{nd} polishing process. It can be also acquired a surface roughness Rmax in the range of 2 nm to 6 nm, and a surface roughness Ra in the range of 0.2 nm to 0.4 nm.

It is preferable that the amount of polishing is from 2 μm to 5 μm. By controlling the amount of polishing to be in this range, the minute roughness or undulation appeared in the surface, or minutes defects such as scratches produced during the manufacturing processes can be efficiently removed.

### (Scrub Cleaning)

Next, scrub cleaning is performed after finishing the polishing process which is a grinding process. Scrub cleaning is a wet physical cleaning method, in which a scrub member is pressed on a cleaning surface (substrate side), while applying a washing liquid, and the scrub member and the cleaning surface is relatively movement with each other so as to rub the dirt on the cleaning surface. As a scrub cleaning apparatus, it can be used a roll scrub leaning apparatus having a scrub member of a cylinder type, and a cup scrub cleaning apparatus having a scrub member of a cup type.

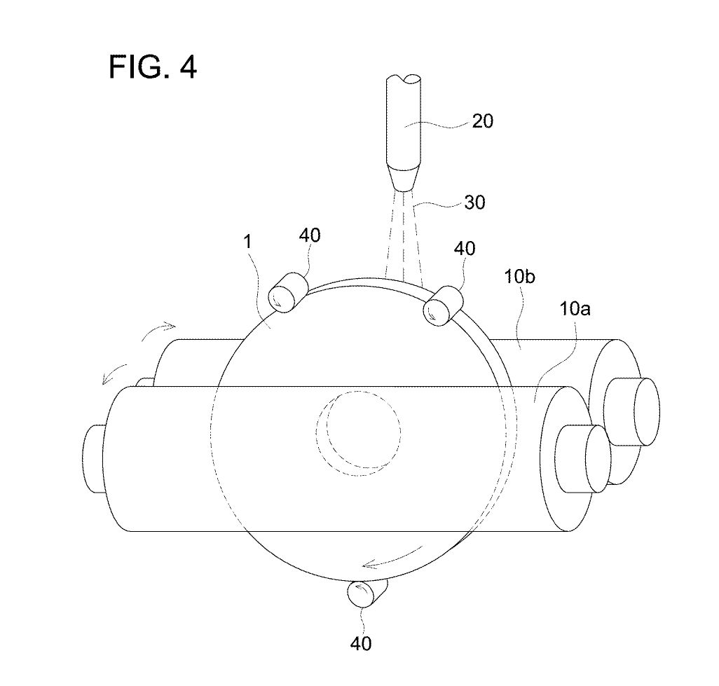

An example of a roll scrub cleaning apparatus is shown in FIG. 4. The roll scrub cleaning apparatus of FIG. 4 puts the glass substrate 1 in the nip part of the sponge rollers 10a and 10b which is a pair of rotary rollers contacted by pressure. The above-mentioned pair of sponge rollers 10a and 10b is rotated to a reverse direction mutually, carrying out dropping or spraying washing liquid 30 from nozzle 20 located at the upper part near the pressure contact part of sponge rollers 10a and 10b and the glass substrate 1. At the same time, the front surface and rear surface of the glass substrate 1 are washed by rotating, while supporting the glass substrate 1 with the support roller 40.

As cleaning requirements for the scrub cleaning, the rotational frequency of two sponge rollers 10a and 10b may be the same respectively, or it may be possible to set the rotational frequency to be different from each other if needed. Generally, the rotational frequency of the sponge roller is in the range of 100 to 1000 rpm, and it is more preferably in the range of 300 to 500 rpm. Moreover, generally, the rotational frequency of the glass substrate 1 is in the range of 50 to 500 rpm, and it is more preferably in the range of 100 to 300 rpm. The rate of feed of the washing liquid 30 is generally in the range of 10 to 1000 ml/minute, and it is more preferably in the range of 50 to 500 ml/minute. The time of the scrub cleaning is generally in the range of 5 to 150 seconds, and it is more preferably in the range of 10 to 100 seconds.

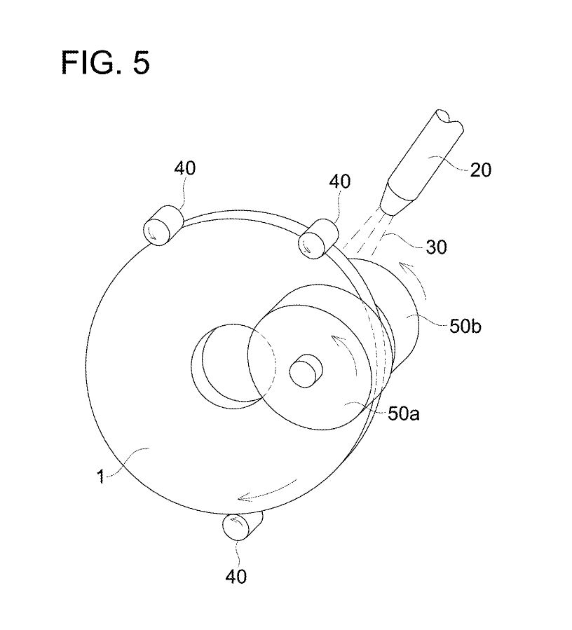

An example of a cup scrub cleaning apparatus is shown in FIG. 5. The cup scrub cleaning apparatus of FIG. 5 puts the glass substrate 1 in the nip part of the sponge rollers 50a and 50b which is a pair of rotary rollers contacted by pressure. The above-mentioned pair of sponge rollers 50a and 50b is rotated to the same direction mutually, carrying out dropping or spraying washing liquid 30 from nozzle 20 located at the upper part near the pressure contact part of sponge rollers 50a and 50b and the glass substrate 1. At the same time, the front surface and rear surface of the glass substrate 1 are washed by rotating, while supporting the glass substrate 1 with the support roller 40.

In addition, although sponge is used for a scrub member since it has an excellent property to capture particles and excellent anti-wear quality, of course, it can be used a fibrous brush or a pad made of cloth.

The sponge materials are not particularly limited. For example, it can be constituted of the following materials: cellulose sponge, polyvinyl alcohol sponge, polyurethane foam, ethylene-vinyl acetate copolymer (EVA) sponge, melamine form, resin system sponge such as polyethylene foam, natural rubber (NR) sponge, polychloroprene rubber (CR) sponge, ethylene-propylene rubber (EPDM) sponge, rubber system sponge such as butadiene acrylonitrile rubber sponge. Among these, it is preferable to constitute the sponge portion with a resin system sponge, i.e., the main material of the sponge should be made of a resin. Moreover, with respect to the above-mentioned resins, it is preferable that they are hydrophilic resin materials, such as polyurethane, melamine resin, cellulose, and a polyvinylalcohol. Thereby, the retention capacity of the dirt by a sponge portion, and the support ability of the washing liquid can be more distinguished. Moreover, a contact area with a glass substrate will be also increased and the clearance ability of dirt will be improved. By adding a further amount of hydrogen peroxide water to the sponge, the hydrophilicity of the surface of the sponge can be raised further, and the clearance ability of dirt can be improved.

Moreover, it is preferable that adjoining holes in the sponge are communicated with each other. This structure should accommodate much quantity of dirt and washing liquid, in the inside of the hole of the porous body which constitutes the sponge, and the retention capacity of the dirt by sponge and the support ability of the washing liquid can be more excellent.

The void ratio of sponge is preferably from 20 to 800, and it is more preferably from 30 to 700. Thereby, the retention capacity of the dirt by sponge and the support ability of the washing liquid can be excelled more, while retaining the required characteristics such as strength of sponge and elasticity.

The hardness of sponge is preferably from 30 to 70° degrees, and it is more preferably from 35 to 55°. Thereby, the retention capacity of the dirt by sponge and the support ability of the washing liquid can be excelled more, while retaining the required characteristics such as strength of sponge and elasticity. Here, the hardness means the value measured based on JIS K7312.

In order to remove effectively an abrasive compound, a foreign matter on a surface of a glass substrate, it is preferable to contact the glass substrate with the same liquid as the above-mentioned washing liquid before performing the scrub cleaning. Although there is no limitation in particular about the time to contact, it is preferable to make it contact for more than 10 minutes in order to float the abrasive compound and the foreign matter which are adhered firmly to the surface of the glass substrate by some corrosion action of the liquid. On the other hand, although it becomes easy to remove the abrasive compound and the foreign matter from the surface of the glass substrate on the other hand in proportion to the contact time of the liquid with the glass substrate, since the manufacturing efficiency of the glass substrate may fall, the preferable contact time is in the range of 5 to 30 minutes. Moreover, from the viewpoint of preventing the foreign matter adhering to the surface of the glass substrate, it is recommended to contact the glass substrate with the liquid just before performing the scrub cleaning.

As a configuration which makes contact a surface of a glass substrate with a liquid, the following conventionally well-known configurations can be adopted: a configuration of immersing a glass substrate in a container storing a liquid, a configuration of sprinkling a liquid to a glass substrate and a configuration of covering a glass substrate with a cloth immersed with a liquid. Among these configurations, the configuration of immersing a glass substrate in a liquid is preferable since the whole surface of the glass substrate can be made contact certainly and uniformly with the liquid.

Thus, the scrub cleaning concerning the present invention is performed and the abrasive compound and the foreign matter adhered to a surface of a glass substrate are removed.

A drying process (not illustrated) is performed to the glass substrate when required after the scrub cleaning was made. Specifically, the drying process is performed as follows. A glass substrate is immersed into IPA (isopropyl alcohol) so that a washing liquid is dissolves in IPA and the coating liquid on the surface of the substrate is substituted with IPA. Then, while exposing the glass substrate into IPA vapor further, IPA is evaporated and the glass substrate is dried. After that, an examination is conducted when required. A drying process of a substrate is not necessarily limited to this, there can be used any drying ways generally known for drying glass substrates, such as spin drying and air knife drying.

### (Texture Treatment Process)

Next, texture treatment process is applied to the glass substrate. This texture treatment process enables to form the line pattern of concentric circle shape on the surface of the glass substrate using a tape polishing method. By the texture treatment process, magnetic anisotropy is given to a magnetic disk medium and the magnetic properties as a magnetic recording medium is improved, and at the same time, it can be prevented from occurring adsorption of the magnetic recording head with the surface of the magnetic disc at the time of non-operation of a hard disc drive.

In order to disperse abrasive grains uniformly in a liquid and to prevent sedimentation of the abrasive grains in a texture treatment liquid under storage, the texture treatment liquid is used as slurry which is prepared by dispersing about 0.01 to 5 weight % of abrasive grains into an aqueous solution containing about 1 to 25 weight % of a surfactant of glycol system compound, such as polyethylene glycols or polypropylene glycol.

Diamond particles of a single crystal or a polycrystal is used as abrasive grains. The particle shape of these diamond particles is regular, there is no dispersion in a grain size and a form, and they are hard and excellent in chemical resistance and heating resistance. In particular, since the particle shape is a round form without an angle as compared with a single crystal, the polycrystal diamond particles are widely used as abrasive grains for precision polishing work.

Surface roughness Ra of the outermost surface of the glass substrate after texture treatment processing is preferably 0.3 nm or less. When the surface roughness Ra is larger than 0.3 nm and when it is used for a magnetic disc, the distance of a magnetic recording head and the surface of the magnetic disc cannot be made small, as a result, a storage capacity of the magnetic disc cannot be increased.

Next, the magnetic recording medium using the glass substrate produced as mentioned above is described.

Hereafter, a magnetic recording medium is described based on the technical drawing.

FIG. 2 shows an oblique perspective view of a magnetic disk. Magnetic disk D is provided with magnetic layer 2 which is directly formed on the surface of circular glass substrate 1 for a recording medium. A conventionally known method can be used as a method for forming the magnetic layer 2. Examples of the forming method of the magnetic layer 2 include a method of forming the magnetic layer by spin-coating a thermosetting resin in which magnetic particles are dispersed on a substrate, a method of forming the magnetic layer via sputtering, and a method of forming the magnetic layer via electroless plating. The layer obtained via spin-coating has a thickness of roughly 0.3 μm to 1.2 μm, the layer obtained via sputtering has a thickness of roughly 0.04 μm to 0.08 μm, and the layer obtained via electroless plating has a thickness of roughly 0.05 μm to 0.1 μm. The film formation carried out via sputtering and electroless plating is preferable in view of thin film formation and high recording density.

Magnetic materials used for magnetic layers are not specifically limited, and commonly known ones are usable, but Co exhibiting high magnetocrystalline anisotropy is taken as a base to acquire high coercive force, and the Co system alloy in which Ni and Cr are added is preferable in order to adjust residual magnetic flux density. Examples of the Co system alloy containing Co as a main component include CoPt, CoCr, CoNi, CoNiCr, CoCrTa, CoPtCr, CoNiPt, CoNiCrPt, CoNiCrTa, CoCrPtTa, CoCrPtB, CoCrPtSiO and so forth. A multilayer structure in which magnetic layers are sandwiched and isolated by non-magnetic layers (Cr, CrMo, CrV and so forth, for example) to make noise reduction may also be utilized. Examples thereof include CoPtCr/CrMo/CoPtCr, CoCrPtTa/CrMo/CoCrPtTa, and so forth. A granular structure in which magnetic particles made of Fe, Co, FeCo, CoNiPt or such are dispersed in a non-magnetic layer formed from a ferrite system, an iron-rare earth system, SiO₂, BN or such, other than the above-described materials may also be utilized. Further, the magnetic layer may also be utilized in any of an in-plane type recording method and a perpendicular type recording method.

A lubricant may be thinly coated on the magnetic layer surface in order to improve sliding of a magnetic head. As the lubricant, provided is one in which a liquid lubricant such as perfluoropolyether (PFPE) is diluted with a freon based solvent.

An underlayer and a protective layer may also be provided, if desired. The underlayer provided for a magnetic disk is selected depending on the utilized magnetic layer. The underlayer is made of at least one selected from the group consisting of Cr, Mo, Ta, Ti, W, V, B, Al and Ni as non-magnetic metals. In the case of a magnetic layer containing Co as a main component, it is preferable that the underlayer is made of a single piece of Cr and a Cr alloy in view of improvement of magnetic properties. Further, the underlayer is not always a single layer, and a multilayer structure in which identical layers or non-identical layers are laminated may be utilized. Examples of the underlayer having the multilayer structure which may be usable include Cr/Cr, Cr/CrMo, Cr/CrV, NiAl/Cr, NiAl/CrMo, NiAl/CrV and so forth.

Examples of the protective layer to prevent wear and corrosion of magnetic layers include a Cr layer, a Cr alloy layer, a carbon layer, a carbon hydride layer, a zirconia layer, a silica layer and so forth. These protective layers, together with underlayers, magnetic layers and so forth can be continuously formed with an in-line type sputtering apparatus. The protective layer may be a single layer, or a multilayer structure in which identical layers or non-identical layers are laminated may be utilized. In addition, a different kind of protective layer may be formed on the above-described protective layer, or the above-described protective layer may be replaced by a different kind of protective layer. For example, in place of the above-described protective layer, a silicon dioxide (SiO₂) layer may be formed on a Cr layer by coating a dispersion composition and further baking the coated dispersion composition. The dispersion composition is composed of colloidal silica particles which are dispersed in tetraalkoxy silane diluted with an alcohol based solvent.

By using the magnetic recording medium which has the glass substrate for an information recording medium of the present invention obtained as described above, it can be possible to stabilize the movement of the magnetic recording head at the time of a high velocity revolution.

The glass substrate for information recording medium of the present invention is not limited to a magnetic recording medium, but it is usable for magnetooptical disks, optical disks and so forth.

### EXAMPLES

### Examples 1 to 5, Comparative Examples 1 to 6

### (1) Glass-Melting and Press-Molding Process

Aluminosilicate glass having a Tg of 480° C. was used as a glass material. The melted aluminosilicate glass was press-molded to prepare a blank material (outer diameter: 68 mm; thickness: 1.3 mm).

### (2) Coring Process

Next, a circle hole (18 mm in diameter) was opened in the central part of the glass substrate using a diamond grindstone of a cylindrical shape.

### (3) 1^{st} Lapping Process

Both surfaces of the glass substrate were polished using the polishing machine (made by HAMAI Corporation).

The polishing condition was as follows: a diamond pellet of #1200 mesh was used, load was set to be 100 g/cm², the rotational frequency of the upper plates was set to be 30 rpm and the rotational frequency of the lower platen was set to be 10 rpm.

The thickness of the obtained glass substrate was 0.9 mm, and surface roughness Rmax was 1.5 μm and Ra was 1.0 μm.

### (4) Inner/Outer Diameter High-Precision Processing Process

The inner and the outer diameter processing were carried out using a drum-form diamond grindstone to achieve an inner diameter of 20 mm and an outer diameter of 65 mm.

### (5) End Surface Polishing Process

100 pieces of the glass substrates after finishing the inner/outer diameter process were piled and the end surfaces of the inner circumference and the outer circumference were polished using an end surface polishing machine.

A nylon fiber of 0.2 mm in diameter was used for the brush hair of the polishing machine. Cerium oxide with a particle size of 3 μm was used for a polishing liquid. The surface roughness of the end face of the inner circumference of the obtained glass substrate was found to be Rmax of 0.3 and Ra of 0.03 μm.

### (6) 2^{nd} Lapping Process

Both surfaces of the glass substrate were polished using the polishing machine (made by HAMAI Corporation).

The polishing condition was as follows: a diamond pellet of #1200 mesh was used, load was set to be 100 g/cm2, the rotational frequency of the upper plates was set to be 30 rpm and the rotational frequency of the lower platen was set to be 10 rpm.

The produced glass substrate has surface roughness Rmax of 3 μm and Ra of 0.3 μm.

### (7) Chemical Strengthening Treatment Process

Next, the glass substrate was immersed in a chemical strengthening liquid to carry out the chemical strengthening process. A mixed fused salt composed of KNO₃ and NaNO₃ was used in the chemical strengthening treatment solution. The mixing ratio of KNO₃ to NaNO₃ was 1:1 by weight. The temperature of the chemical strengthening treatment solution was set to be 400° C. and the immersing time was set to be 40 minutes.

### (8) Polishing Process

Next, a foaming urethane having hardness A of 80 degrees was used for the pad, using the polishing machine (made by HAMAI Corporation) in the 1^{st} polishing process of a polishing process. The abrasive compound is employed as a slurry form prepared with cerium oxide of an average diameter of 1.5 μm by dispersing in water. Mixed ratio of water to the abrasive compound was set to be 2:8. The load was set to be 100 g/cm², and the rotational frequency of the upper plates was set to be 30 rpm and the rotational frequency of the lower platen was set to be 10 rpm. Polishing quantity was set to be 30 μm.

The produced glass substrate has surface roughness Rmax of 30 nm and Ra of 3 nm.

Next, a foaming urethane having hardness A of 70 degrees was used for the pad, using the polishing machine (made by HAMAI Corporation) in the 2^{nd} polishing process of a polishing process. The abrasive compound is employed as a slurry form prepared with cerium oxide having an average diameter of 60 nm by dispersing in water. Mixed ratio of water to the abrasive compound was set to be 2:8. The load was set to be 90 g/cm², and the rotational frequency of the upper platen was set to be 30 rpm and the rotational frequency of the lower platen was set to be 10 rpm. Polishing quantity was set to be 3 μm.

The produced glass substrate has surface roughness Rmax of 5 nm and Ra of 0.3 nm.

### (9) Scrub Cleaning Process

The scrub cleaning was done using a cleaning apparatus shown in FIG. 4 after termination of the 2^{nd} polishing process. The scrub cleaning was performed using hydrogen peroxide water having a hydrogen peroxide concentration shown in Table 1 as a washing liquid. Supply of the washing liquid was done continuously from 3 seconds before the initiation of the scrub cleaning till the termination of the scrub cleaning with a spraying method. The amount of supply of the washing liquid was 100 ml/minute. A polyvinyl alcohol sponge was used as a sponge of a scrub member. The void ratio of the sponge was 50% and hardness of the sponge was 45° (JIS K7312).

Thus, in Examples 1 to 5 and Comparative examples 1 to 6, 10,000 pieces of glass substrates were produced at a time, respectively, and the dirt of 100 sheets taken from the first stage and another 100 sheets taken from the 9,900^{th} sheet to the last 10,000^{th} sheets were evaluated.

The examination of the dirt of the produced glass substrates was conducted using a scanned type laser disc surface-analysis apparatus, and minute adhesion materials on the surface of the glass substrate were evaluated. Relative evaluation was made based on the minute adhesion materials on the comparative example 1 treated with 0% of the hydrogen peroxide concentration for the sum of the quantity of the minute adhesion materials on 100 sheets. In the evaluation rank, the relative value of 0 to 0.5 is “A”, larger than 0.5 to 0.7 is “B”, larger than 0.7 to 0.8 is “C” and larger than 0.8 to 1.0 is “D”. In addition, since the occurrence of reading errors by the reading head for a magnetic disc will become high when the relative value of the adhesion materials exceeds 0.8, 0.8 or less are required as a commercially viable product.

An evaluation results are shown in Table 1.

TABLE 1

| | | Minute | | Minute | |
|---|---|---|---|---|---|
| | Concentration | adhesion | Rank | adhesion | |
| | of | materials | for | materials | Rank for |
| | hydrogen | in the | the | after the | after the |
| | peroxide | first | first | durability | durability |
| | (%) | stage | stage | stage | stage |
| Comparative | 0.0 | 1.00 | D | 1.00 | D |
| example 1 | | | | | |
| Comparative | 0.3 | 0.84 | D | 0.95 | D |
| example 2 | | | | | |
| Comparative | 0.4 | 0.76 | C | 0.83 | D |
| example 3 | | | | | |
| Example 1 | 0.5 | 0.67 | B | 0.74 | C |
| Example 2 | 1.0 | 0.39 | A | 0.65 | B |
| Example 3 | 2.0 | 0.31 | A | 0.45 | A |
| Example 4 | 3.0 | 0.34 | A | 0.66 | B |
| Example 5 | 5.0 | 0.23 | A | 0.73 | C |
| Comparative | 5.6 | 0.20 | A | 0.82 | D |
| example 4 | | | | | |
| Comparative | 7.0 | 0.19 | A | 0.89 | D |
| example 5 | | | | | |
| Comparative | 10.0 | 0.18 | A | 0.93 | D |
| example 6 | | | | | |

In Table 1, from the results obtained from the 100 sheets of the first stage, it is shown that Comparative examples 1 to 3 have the hydrogen peroxide concentration of a washing liquid as thin as 0 to 0.4, and their hydrophilicity of the surface of the scrub member was not improved so much. Therefore, since the contact area of the scrub member and the glass substrate was insufficient, it is shown that that effective cleaning cannot be performed. Moreover, in Comparative examples 4 to 6, the hydrogen peroxide concentration of the washing liquid is as high as 5.6 to 10.0. With respect to the 100 sheets from the 9,900^{th} sheet to the 10,000^{th} sheet taken from after the durability stage, it is shown that that the surface of the scrub member deteriorates with durability process, and effective cleaning cannot be done.

Thus, it is demonstrated that a good cleaning effect is performed when the hydrogen peroxide concentration is 0.5 to 5.0 weight % as shown in Examples 1 to 5 during the first stage and after the durability stage.

1. A method for manufacturing a glass substrate for an information recording medium comprising the step of:
scrub cleaning the glass substrate using a scrub member and a washing liquid,
wherein the washing liquid is hydrogen peroxide water containing hydrogen peroxide in an amount of 0.5 to 5.0 weight %.

2. The method for manufacturing a glass substrate for an information recording medium of claim 1,
wherein the washing liquid is hydrogen peroxide water containing hydrogen peroxide in an amount of 1.0 to 3.0 weight %.

3. The method for manufacturing a glass substrate for an information recording medium of claim 1,
wherein the method comprises the step of:
polishing the glass substrate; and then
scrub cleaning the glass substrate after polishing the glass substrate.

4. The method for manufacturing a glass substrate for an information recording medium of claim 1,
wherein the scrub member is a rotary roller having a sponge on a surface of the rotary roller, scrub cleaning is carried out by making contact the rotary roller with the glass substrate, and the washing liquid is dropped in a vicinity of a contact portion of the rotary roller with the glass substrate.

5. The method for manufacturing a glass substrate for an information recording medium of claim 4,
wherein the sponge has a void ratio of 20 to 80%.

6. The method for manufacturing a glass substrate for an information recording medium of claim 4,
wherein the sponge has a hardness of 30 to 70.

7. The method for manufacturing a glass substrate for an information recording medium of claim 4,
wherein the sponge is made of a hydrophilic resin material.

8. A glass substrate for an information recording medium produced with the method of claim 1.

9. A magnetic recording medium comprising the glass substrate of claim 8 and a magnetic layer which is provided on a surface of the glass substrate.
